(19) United States
(12) Patent Application Publication
(10) Pub. No.: US 2005/0125442 A1
(43) Pub. Date: Jun. 9, 2005

(54) Producing domestic relations orders

(76) Inventors: Brian D. Oxman, Brookfield, MA (US); David R. Hupper, Groton, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/729,517

(22) Filed: Dec. 5, 2003

(51) Int. Cl. G06F 17/00

(52) U.S. Cl. 707/103 Y

(57) ABSTRACT

This invention relates to computerized systems and methods for producing domestic relations orders (DRO's). In one embodiment, a computerized system for producing DROs includes a receiver for receiving information relating to a domestic relations order, a rules engine for authenticating the received information, and a document assembler for automatically incorporating the received information into a domestic relations order.

### TECHNICAL FIELD

This invention relates to computer-based methods and systems for producing legal documents and, more particularly, to computerized methods and systems for producing domestic relations orders.

### BACKGROUND INFORMATION

Individuals currently depend on numerous sources of post-retirement income in order to maintain a high quality of life. In the past, typical American workers often relied on an employer funded retirement plan (such as a pension plan) and Social Security as their primary sources of retirement income. However, many companies no longer offer pension plans, and even those that do may not have the capabilities to perform the necessary record keeping functions in a sufficient manner. Furthermore, most individuals recognize that Social Security is not sufficient as a primary source of post-retirement income, and many even doubt its long-term financial viability. To supplement these two sources of income, many employees participate in so-called “defined contribution plans”—commonly referred to as 401k or 403b plans—which are offered to the employees by their employer (the plan “sponsor”) as part of an employee benefits package. Further, because of the detailed and intricate statutory requirements of these plans, many plan sponsors outsource the record keeping functions to a financial services company or data processing company (the plan “record keeper”).

Many of these plans allow employees to designate some amount (often a pre-tax percentage or dollar amount) of their salary to one or more investment vehicles such as stocks, bonds, mutual funds, money market accounts, as well as others. After contributing to such a plan over the span of an entire career, an employee can compile a significant retirement “nest-egg” that will help maintain their pre-retirement standard of living.

However, because these plans are statutory in nature and governed by the Internal Revenue Code (IRC) and Employee Retirement Income Security Act (ERISA), the record keeping functions associated with these plans is complex and highly regulated. One such example is the creation, execution, and processing of domestic relations orders, or “DROs.” DROs function as an order from a court expressly instructing a plan record keeper to distribute funds from an account according to the terms of the order.

For example, if a participant in a defined contribution plan accumulates a large amount of money in an account and subsequently divorces their spouse, it is possible that under a property settlement some portion of the funds in the account may be allocated to the spouse. In such a case, the plan record keeper must receive a properly drafted and executed DRO (often referred to as a Qualified Domestic Relations Order or “QDRO”) from a court of proper jurisdiction prior to disbursing the funds. However, plan record keepers currently receive many DROs that contain incorrect information and therefore cannot be processed in a timely manner. DROs that fail to comply with the IRC, ERISA, and plan sponsor guidelines are deemed “non-compliant,” and are therefore rejected, leading to delays in the availability of funds. Therefore, plan record keepers often spend significant amounts of time and effort to obtain the correct information, incorporate the information into a proper format, and process the order according to the terms of the order.

### SUMMARY OF THE INVENTION

In general, the invention relates to computer-based methods and systems that allow a participant of an employee benefits plan, a delegate of a participant, an alternate payee, or a delegate of an alternate payee (referred to herein as the “user”) to draft a domestic relations order that complies with the relevant statutory requirements and the plan documents.

In some aspects, the users can create domestic relations orders by, for example, answering a series of questions via an online questionnaire. The answers are combined with standard text and standard templates, and a completed domestic relations order is produced that complies with the IRC and ERISA. In some embodiments, the user's answers are limited to a defined set of valid responses, which are subsequently integrated with appropriate standard language. The system then automatically produces a domestic relations order that is more likely to comply with the relevant statutes and rules than a DRO produced using traditional means, and therefore it can be executed by the necessary parties. Thus, when the plan record keeper receives the DRO with the correct information, formatted correctly, and using pre-approved language, the record keeper can qualify the order and process it according to its terms without additional reviews and processing that may lead to delays, errors, and/or rework.

While particularly useful for defined contribution plans, these methods and tools are not limited to that specific application, and can be used to design similar plans such as pension plans, medical plans, as well as other benefit plans requiring formal documentation.

In some aspects, the invention provides a computerized system for producing a domestic relations order includes a receiver for receiving information relating to a domestic relations order, a rules engine in communication with the receiver for authenticating the received information, and a document assembler for automatically incorporating the authenticated information into an assembled domestic relations order. A subset of the received information can be received from a participant in an employee benefit plan, a legal representative of the participant of the plan, or an alternate payee of the plan.

In some embodiments, the system can also include a data storage device for storing rules relating to the domestic relations order, sample text passages for the order, which may, in some embodiments, relate to the domestic relations order, and completed domestic relations orders. In some embodiments, the rules engine can select a subset of the stored sample text passages based at least in part on the stored rules or the received information. In some embodiments, the document assembler receives at least a subset of the information from the data storage device, the subset of received information having been included in a previously assembled domestic relations order. In other embodiments, the system may also include an administrative module for maintaining the rules engine.

In other aspects, the invention relates to computerized methods for producing a domestic relations order. The method includes providing a plurality of sample text passages, the sample text passages including embedded parameters and relating to domestic relations orders. Information relating to a domestic relations order is requested and received, the requested information including values for one or more of the embedded parameters. A domestic relations order is then automatically assembled using a subset of the sample text passages and at least a subset of the received information. In some embodiments, the designation step determines if the domestic relations order complies with the Internal Revenue Code and the Employee Retirement Income Security Act. In some embodiments, the method further includes receiving the information though an online questionnaire over an electronic communications network such as a local area network, a wide area network, a telephone network, an intranet, and the Internet.

In one embodiment, the method includes receiving at least a subset of the information from a previously completed domestic relations order. Some or all of the information can be received from a participant in an employee benefit plan, a legal representative of the participant in the employee benefit plan, and an alternate payee of an employee benefit plan. The employee benefit plan can be a defined contributions plan or, in some embodiments, a defined benefit plan.

In another embodiment, the method may also include providing a set of rules relating to the composition of a domestic relations order, and in some embodiments using the rules to determine the subset of the sample text passages used to assemble the domestic relations order.

Another aspect of the invention provides a computerized system for producing a domestic relations order, including a means for storing sample text passages for inclusion into a qualified domestic relations order, the sample text passages including embedded parameters; means for receiving information about a first domestic relations order, the received information including values for the embedded parameters; and means for automatically assembling a domestic relations order from the received information and a subset of the stored sample text.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram of an embodiment of the invention.

FIG. 2 is a block diagram of an embodiment of a system according to the invention.

FIG. 3 is a block diagram of an embodiment of a server in the system of FIG. 2.

FIG. 4 is a flowchart of an embodiment of a method according to the invention.

FIG. 5 is a flowchart of an embodiment of a method according to the invention.

FIG. 6 is a screen display of a member registration screen of an embodiment of the invention

FIG. 7 is a screen display of a create new QDRO screen of an embodiment of the invention.

FIG. 8 is a screen display of a plan level data screen in an embodiment of the invention.

FIG. 9 is a screen display of a plan level questions screen in an embodiment of the invention.

FIG. 10 is a screen display of a help screen in an embodiment of the invention.

FIG. 11 is a screen display of a plan level questions screen in an embodiment of the invention.

FIG. 12 is a screen display of an attorney information screen in an embodiment of the invention.

FIG. 13 is a screen display of an alternate payee information screen in an embodiment of the invention.

FIG. 14 is a screen display of an attorney information screen in an embodiment of the invention.

FIG. 15 is a screen display of a court information screen in an embodiment of the invention.

FIG. 16 is a screen display of verification screen in an embodiment of the invention.

FIG. 17 is a screen display of a confirmation screen in an embodiment of the invention.

FIG. 18 is a screen display of a summary screen in an embodiment of the invention.

FIGS. 19A and 19B are sample templates for a domestic relations order in an embodiment of the invention.

### DETAILED DESCRIPTION

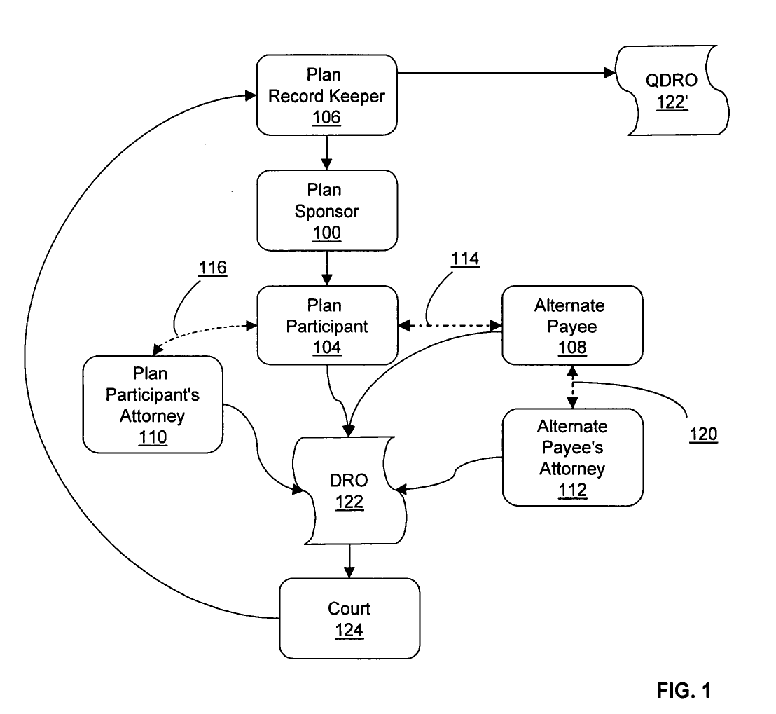

Referring to FIG. 1, in one embodiment, a plan sponsor (“sponsor”) 100 provides one or more employee benefit plans (“plans”) to its employees (“participants”) 104, who may participate in the plans. Because of the significant overhead and regulatory requirements involved in the development and record keeping aspects of the plans, many plan sponsors 100 contract with a plan record keeper (“record keeper”) 106 to provide these services. Examples of plan record keepers include financial services companies such as banks, brokerage houses, insurance companies, and individual financial advisors, as well as data processing companies. In some cases, the record keeper 106 acts as a plan administrator as defined by ERISA and has fiduciary responsibilities toward the plan sponsor, and in some cases may have no such relationship with the sponsor 100.

Some of the services supplied by the plan record keepers 106 are ongoing, i.e. they relate to the day to day operation of the plan. Examples of such services include customer service support, accounting services, distributing educational materials, providing financial information, as well as others. Other may include “event based” services—i.e. they are provided when a particular event occurs to a plan participant 104. Examples of these services include enrollment services, fund transfers, designation of beneficiaries, and making other changes to the terms of the plan based on “life events.” Such life events may include the birth or adoption of a child, the marriage or divorce of the participant 104, or the death of the participant 104. In some cases, where the life event warrants a redistribution or reallocation of the funds in a participant's account, record keepers 106 must have the proper documentation to make such changes. In some cases such as the divorce or death of a plan participant 104, this documentation is referred to as a domestic relations order, or “DRO” 122.

In one embodiment, the plan record keeper 106 provides plan services to a plan sponsor 100, who in turn offers the plan to one or more plan participants 104. When a life event occurs such that the plan participant 104 (or a designated representative of the participant) must submit a domestic relations order to the record keeper 106, the participant completes an online questionnaire, or identifies one or more designated representatives to do so. Examples of designated representatives include an alternate payee 108 (such as an ex-spouse or widow), the participants attorney 110, or in some cases the alternate payee's attorney 112. In other embodiments, the permission to authorize the alternate payee 108 or the participant's attorney 110 to complete the DRO 122 can come from the participant 104 (signified as dashed lines 114 and 116, respectively). In still other embodiments, once an alternate payee 108 has been authorized to complete the DRO 122, the alternate payee may have their attorney 112 complete the form (signified as dashed line 120). In still other embodiments, some of the information requested on the online questionnaire may be provided by one of the parties (participant 104, alternate payee 108, participant's attorney 110, or alternate payee's attorney 112) and the remaining information may be provided by another party.

Once completed, the DRO 122 can be printed, executed by the parties, and submitted to the proper court 124. Upon entry by the court 124, the plan record keeper 106 reviews the court order, compares it to the data entered into the questionnaire, certifies it as QDRO 122′ and if accurate, allocates the benefit pursuant to the order.

Because the questionnaire is presented by the plan record keeper 106, a subset of the data items needed to complete the DRO 122 are known and can be checked for accuracy and completeness upon entry into the questionnaire. By providing a fixed set of choices and applying a set of rules against which the participant's responses can be compared, the likelihood that the completed DRO 122 contains accurate information, and that when merged with the appropriate standard language adheres to the proper format for a qualified DRO is significantly enhanced. This allows for a simplified and shortened qualification process, thus providing participants 104 and alternate payees 108 a quality service and quicker access to the funds or benefit.

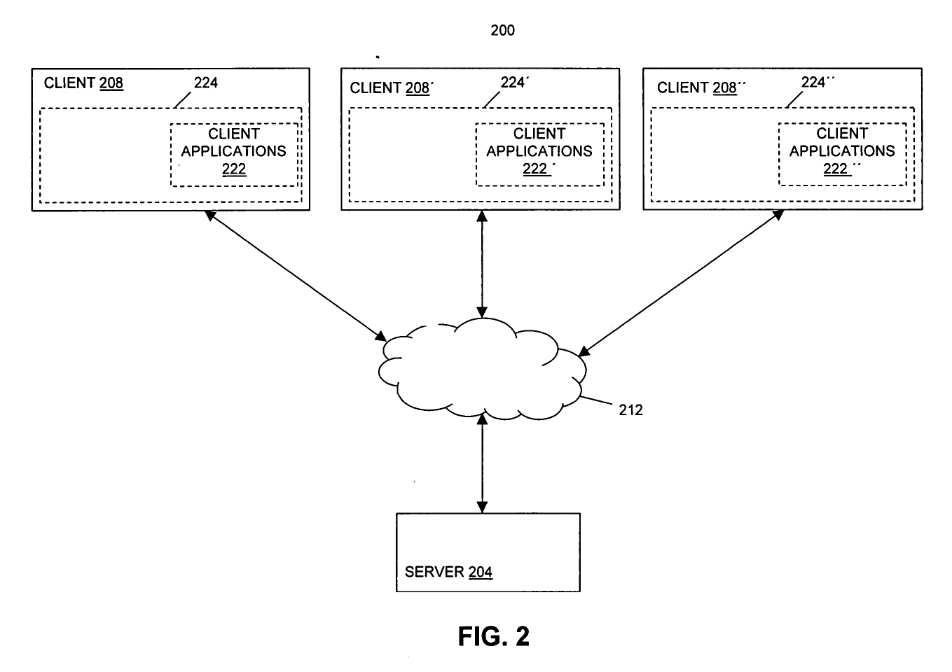

Referring to FIG. 2, in one embodiment, the methods described above may be implemented using a QDRO production system 200 including at least one server 204, and at least one client 208, 208′, and 208″, generally 208. As shown, the system 200 includes three clients 208, 208′, 208″, but this is only for exemplary purposes, and it is intended that there can be any number of clients 208. The client 208 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 208 could also be implemented on such hardware as a smart or dumb terminal, network computer, personal data assistant, wireless device, information appliance, workstation, minicomputer, mainframe computer, kiosk, or other computing device, that is operated as a general purpose computer or a special purpose hardware device solely used for serving as a client 208 in the QDRO production system 200.

Generally, the plan participants 104 or their designees (108, 110, 112) operate the clients 208. In various embodiments, the client computer 208 includes client applications 222. One example of a client application 222 is a web browser application that allows the client 208 to request a web page (e.g. from the server 204) with a web page request. An example of a web page is a data file that includes computer executable or interpretable information, forms, graphics, sound, text, and/or video, that can be displayed, executed, played, processed, streamed, and/or stored and that can contain links, or pointers, to other web pages. In one embodiment, a user of the client 208 manually requests a web page from the server 204. Alternatively, the client 208 automatically makes requests with the web browser. Examples of commercially available web browser software are INTERNET EXPLORER, offered by Microsoft Corporation of Redmond, Wash., and NETSCAPE NAVIGATOR, offered by AOL/Time Warner of Mountain View, Calif.

A communications network 212 connects the client 208 with the server 204. The communication may take place via any media such as standard telephone lines, LAN or WAN links (e.g., T1, T3, 56 kb, X.25), broadband connections (ISDN, Frame Relay, ATM), wireless links, and so on. Preferably, the network 212 can carry TCP/IP protocol communications, and HTTP/HTTPS requests made by the web browser and the connection between the client applications 222 and the server 204 can be communicated over such TCP/IP networks. The type of network is not a limitation, however, and any suitable network may be used. Typical examples of networks that can serve as the communications network 212 include a wireless or wired ethernet-based intranet, a local or wide-area network (LAN or WAN), and/or the global communications network known as the Internet, which may accommodate many different communications media and protocols.

In some embodiments, a record keeper 106 operates a central server 204, which interacts with clients 208. In some embodiments, a third party may manage the server 204, which may include providing the hardware, communications, and service to the server 204. The server 204 is preferably implemented on one or more server class computers that have sufficient memory, data storage, and processing power and that run a server class operating system (e.g., SUN Solaris, GNU/Linux, MICROSOFT WINDOWS 2000, or other such operating system). Other types of system hardware and software than that described here could also be used, depending on the capacity of the device and the number of users and the amount of data received. For example, the server 204 may be part of a server farm or server network, which is a logical group of one or more servers. As another example, there could be multiple servers 204 that may be associated or connected with each other, or multiple servers could operate independently, but with shared data. As is typical in large-scale systems, application software could be implemented in components, with different components running on different server computers, on the same server, or some combination.

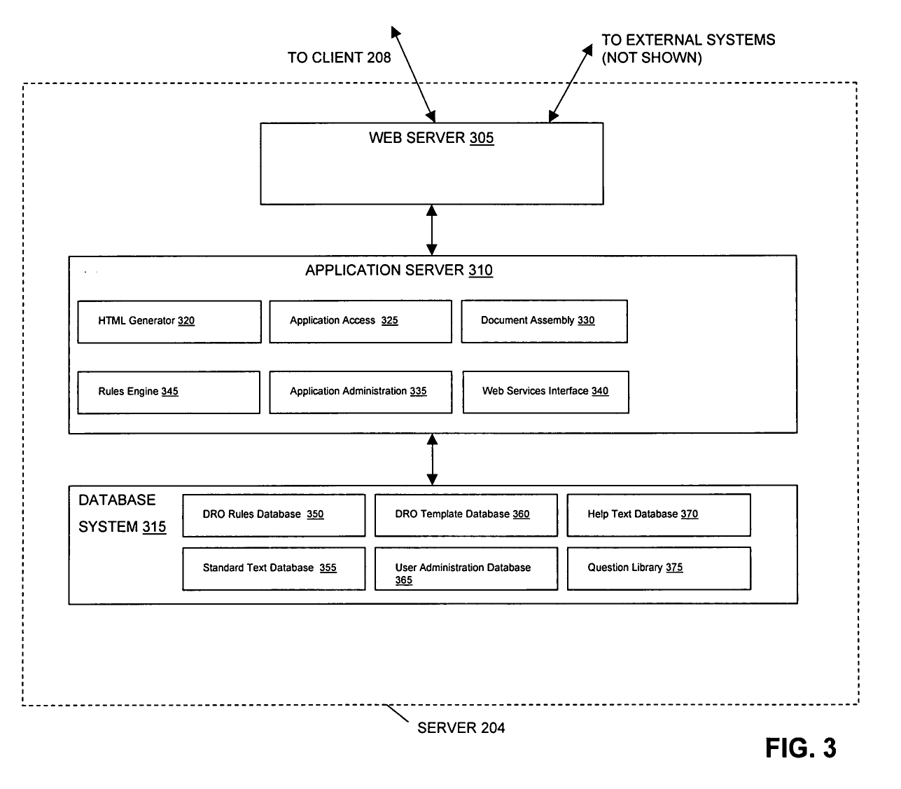

Referring to FIG. 3, in one embodiment, a server 204 includes a web server module 305, an application server 310, and a database system 315. The web server module 305 is the interface for communication with clients 208 and external systems (not shown) involving the transfer of files and data. In some embodiments, the web server module 305 is the interface for communication with clients 208 involving HTTP/S requests and responses, Java messages, SMTP messages, POP3 messages, instant messages, as well as other electronic messages. In some instances, messages may be transferred from the client 208 to the server 204, from the server 204 to the client 208, or both. The web server module 305 can be implemented as software running on one or more servers, or may be implemented as a stand-alone server. In some embodiments, the web server module 305 can provide an interface to client applications 222, so that, for example, a user can send and receive e-mail, instant messages, HTML files, and so on.

The web server module 305 communicates with the application server 310, which provides the main programming logic for the operation of the system 200. In one embodiment, the application server 310 is implemented as one or more application programs (e.g., Internet Information Server from Microsoft Corporation, WebSphere from International Business Machines Corporation, or other such application) running on a server class computer, which may be the same or different computer as the web server module 305. The application server 310 receives data regarding a DRO (such as participant information, plan information, the pending changes to the distribution of funds from an account, etc.) from users via a client 208 and the web server module 305. The application server 310 may also receive requests for data stored in a database (such as lists of available plans, definitions, user accounts, existing DROs, etc.) from users via a client 208 and the web server module 305.

The application server 310 includes an HTML generation engine 320, an application access module 325 for managing user authentication and access, a document assembly module 330, a rules engine 345, an application administration module 335 for managing application procedures and logic, and a web services interface module 340 for requesting and receiving data from other external systems via XML/SOAP, FTP, API's, or other known file and data transfer technologies. The HTML generation engine 320 reads static HTML stored in files on the application server 310 and requests data from a database system 315 to produce completed HTML pages, which in turn are sent to the client 208 via the web server 305. The HTML pages may, in some cases, include data or text directed to a specific user, regarding a specific plan, a specific DRO, or other context dependent data. In some embodiments, the compilation of HTML code uses the Active Server Page (“ASP”) technology from Microsoft Corporation of Redmond, Wash. to combine static HTML and data or context specific data into one or more HTML pages prior to being sent to the client 208. In some embodiments, JAVA, JavaScript, XML, or other like programming languages can be used to generate HTML code or present data, text and/or graphics to a user. In one embodiment, the HTML pages include forms, which are presented to a user on the client 208. The forms allow the user to input data, select from a series of options, and provide other responses to questions presented on the page. In one exemplary embodiment, the data refers to the allocation of funds from an employee benefit plan based on a qualified domestic relations order. Upon completing a form, the user sends the completed questionnaire via an HTML post command to the web server 305, which in turn provides the necessary data to the application server 310 and the database system 315.

The rules engine 345 uses the rules stored in the database system 315 and the information received from the user of the system via the online questionnaire and the web server 305 to determine follow-on questions for the online questionnaire to be sent to the user via the web server 305, the correct DRO template to use as a model for the DRO, and the standard text phrases to use for constructing the DRO. For example, if a user of the system provided information that the DRO relates to alimony payments, the rules engine determines that the valid set of answers to questions regarding the relationship of the alternate payee 108 to the participant 104 may be “spouse” and “former spouse.” Further, additional questions relating to the children of the participant 104 may be skipped, as that information is not relevant to the particular DRO relating to alimony payments. By limiting the questions to those that are relevant to that particular DRO, and limiting one or more of the potential answers to a valid set of pre-determined answers, the variability of the resulting DRO is reduced, thus improving the speed at which it can be processed and reducing the costs associated with qualifying the DRO as a QDRO.

The document assembly module 330 receives data relating to a domestic relations order from the client 208 via the web server 305 and from the database system 315 and creates a document by combining received data, stored sample text passages, and predefined document formats into an assembled DRO. The document can be stored in any one of standard electronic formats. In some embodiments, the document assembly module 330 produces the document in a format such as those used by word processing applications such as Word by Microsoft Corporation. In one exemplary embodiment, the document assembly module 330 produces the document in post-script format such that a non-editable version of the document can be viewed and printed from a commercially-available post-script document viewer such as Adobe Acrobat from Adobe Systems of San Jose, Calif.

Continuing to refer to FIG. 3, the server 204 also includes a database system 315, for storing data related to the production of DROs. For instance, the database server 315 may store information relating to the rules governing the questions, answers, and standard text used to build a DRO, attributes of the plans, stored content, user information, server availability, and web traffic information. The database server 315 may also contain separate databases for the rules 350, standard text 355, DRO templates 360, a user question library 375, user administration 365, help text 370, and others. The database server 315 also provides data to the application server 310 upon request, and manages data updates as instructed by the application server 310. Examples of the database server 315 include the MySQL Database Server by MySQL AB of Uppsala, Sweden, the SQLServer database system of Microsoft Corporation of Redmond Wash., and the ORACLE Database Server offered by ORACLE Corp. of Redwood Shores, Calif.

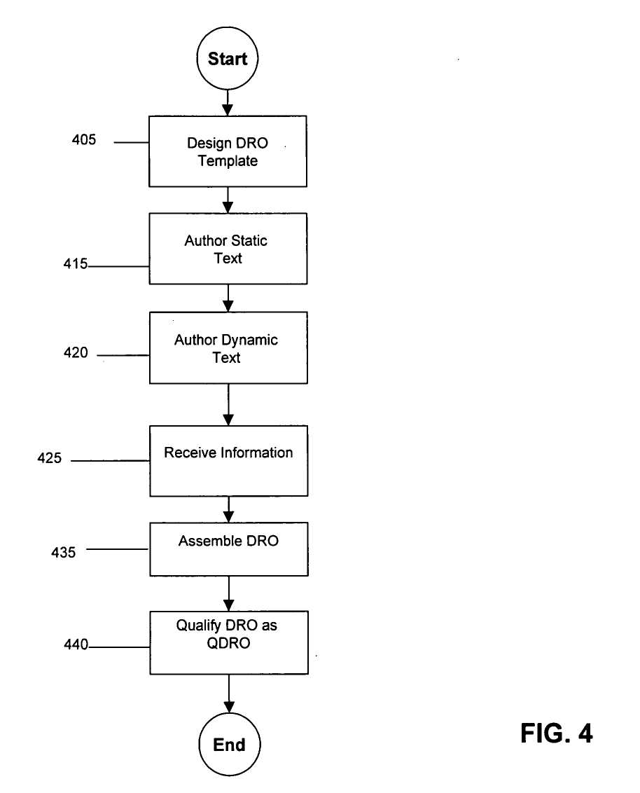

FIG. 4 illustrates one embodiment of a computerized method for creating a DRO. Initially, a plan record keeper 106 designs one or more QDRO templates using one or more standard document template production methods well known in the industry (STEP 405). The templates can comprise both static text (standard language used on all DROs and standard language used on a certain classes of DROs) and blank parameter data fields into which the information supplied by the user is entered as values for the parameters. As part of the templates, the plan record keeper 106 also authors the static text (STEP 415) and dynamic text (STEP 420) which can be stored in the database system 315. Subsequently, the system 200 receives notification that a user wishes to create a DRO, and receives information from the user regarding the custom attributes of the DRO (STEP 425). The user may be a plan participant 104, an alternate payee 108, or a legal representative of either. In some cases, one user can create the DRO, and provide their user authentication to another user of the system, who in turn can review, complete, or modify the DRO, or in some cases create a new DRO using the previously entered information. The document assembly module 330 then assembles the DRO into a document for execution and submission to the court (STEP 435). Upon return of the DRO to the plan record keeper 106, the DRO is qualified as a QDRO by checking the accuracy of the data and that the necessary regulatory requirements have been met (STEP 440).

Using such a method, each party has an opportunity to review the DRO, the information used to create the DRO can be confirmed, and the overall format is consistent and correct. As a result, when the DRO is returned to the plan record keeper 106 after execution and submission to the court, it can be processed with minimal error checking and review.

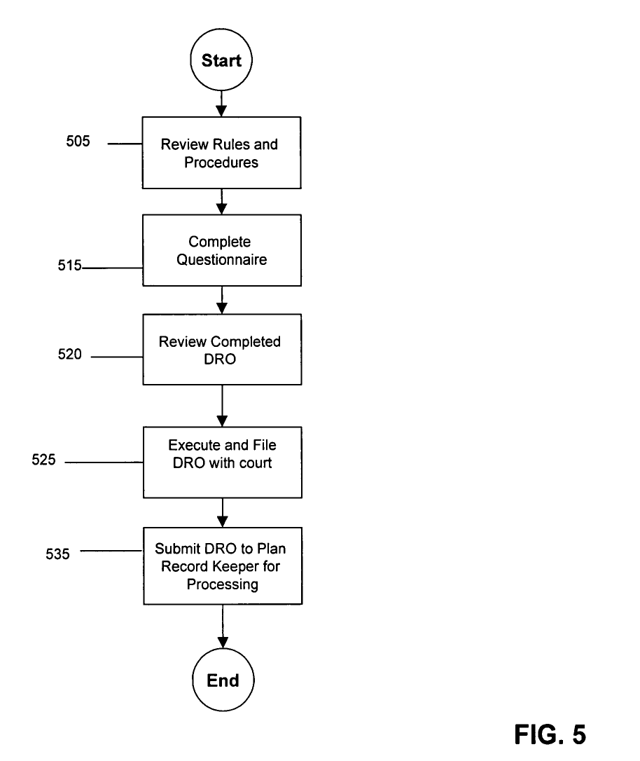

FIG. 5 illustrates an embodiment of a computerized method for allowing a plan participant 104 to create a DRO. The plan participant 104 first reviews the rules and procedures for creating a DRO, which may include reviewing online documents, help files, or other published materials (STEP 505). Once the participant has the necessary information, they complete all or part of the online questionnaire (STEP 515), and review the resulting DRO (STEP 520). The online questionnaire may include questions pertaining to the employer of the plan participant, the specific plan being modified by the DRO, the parties affected by the DRO, as well as other information. The plan participant 104 executes the document (which may also require an alternate payee's signature, notarization, or other legal reviews or signatures) and submits the DRO to the proper court (STEP 525). Once the court approves the DRO, the plan participant 104 submits the DRO to the plan record keeper 106 for processing (STEP 535). Once qualified as a QDRO, the plan record keeper 106 then allocates or disburses funds from the plan(s) pursuant to the QDRO.

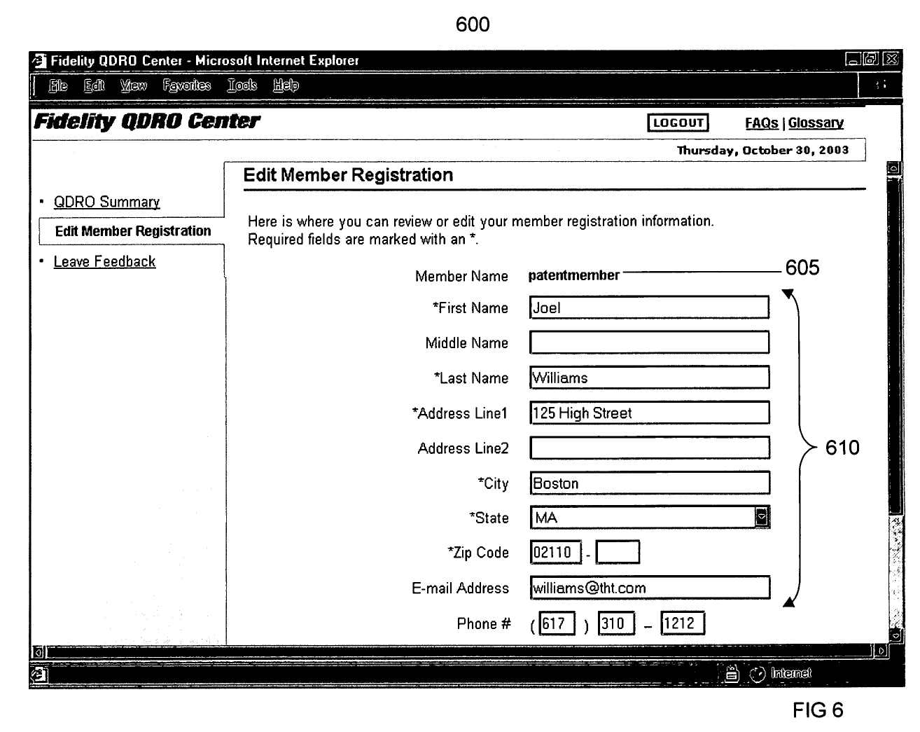

FIGS. 6 through 19B illustrate one embodiment of a system for implementing the methods and systems described above. Referring to FIG. 6, in one exemplary embodiment, the application server 310 provides a member registration screen 600 to the client 108 via the communications network 112. The member registration screen 600 provides a starting point where the user can create a user account and provide contact information. Included on the screen 600 are fields displaying a user identifier (“Member Name”) 605 and various fields for providing full name, address, and telephone contact information 610. In some embodiments, this information may be reused to pre-populate the plan participant information section of the online questionnaire.

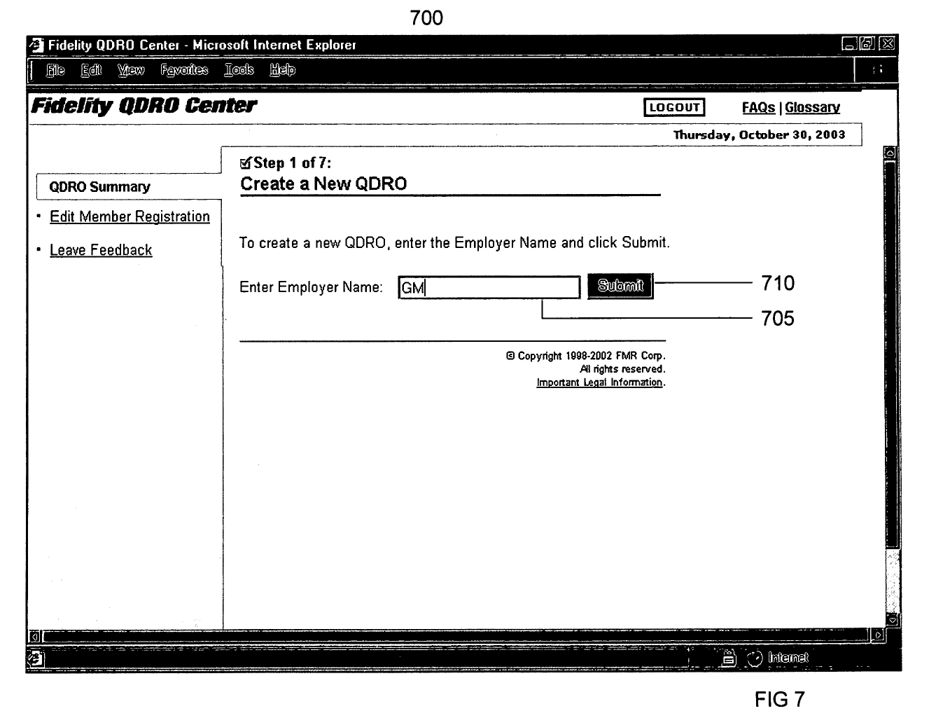

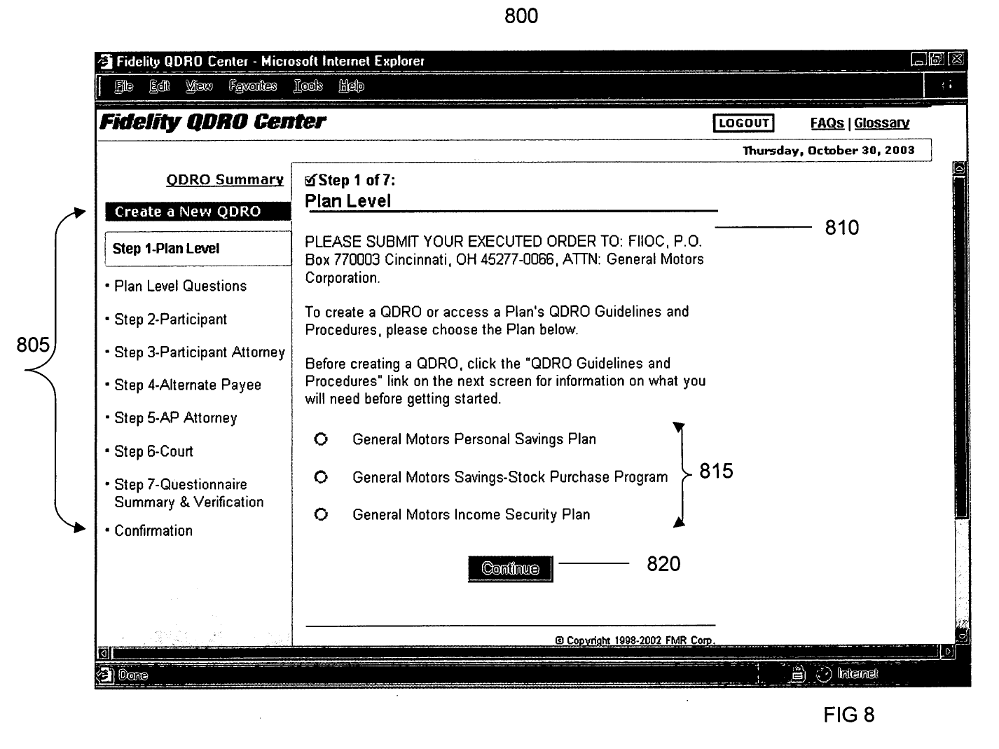

Referring to FIG. 7, once a user creates a user identifier and provides contact information described above, the application server 310 provides a create new QDRO screen 700 to the client 108 via the communications network 112. The create new QDRO screen 700 includes a text field 705 into which a user provides the plan participant's employer name, and a submit button 710 to instruct the system to request information from the database system 315 about the plans offered by that participant's employer. Once the user proves the employer name, the plan level screen 800 illustrated in FIG. 8 provides additional information and instructions to the user. The plan level screen 800 provides a step-by-step roadmap 805 of the steps the user will perform to create the DRO, one or more submission addresses 810 to which the DROs may be submitted once they are executed, and a listing 815 of the plans for which the DRO preparation services have been made available. Once the user has selected the correct plan, they may continue the process by selecting the continue button 820.

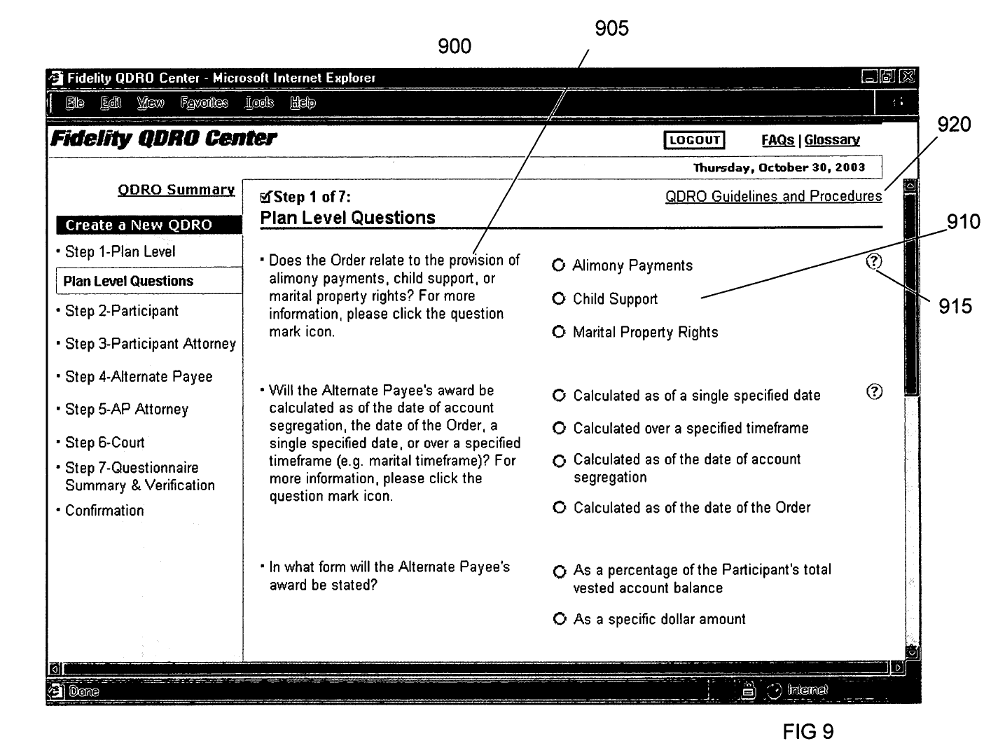

Referring to FIG. 9, once a user has selected a plan, the system provides a plan level questions screen 900. The plan level questions screen 900 includes a set of questions 905, potential answers 910 to the questions 905, and an icon 915 for receiving help about a particular question. In some embodiments, a fixed set of potential answers are stored in the database system 315 thus guaranteeing that the user will select a valid option with the correct spelling, legal terms, etc. and the resulting DRO will be more accurate. In some embodiments, the questions 905 and answers 910 can be selected from the database system 315 based on the participant, the participant's employer, the plan selected, and previously provided answers.

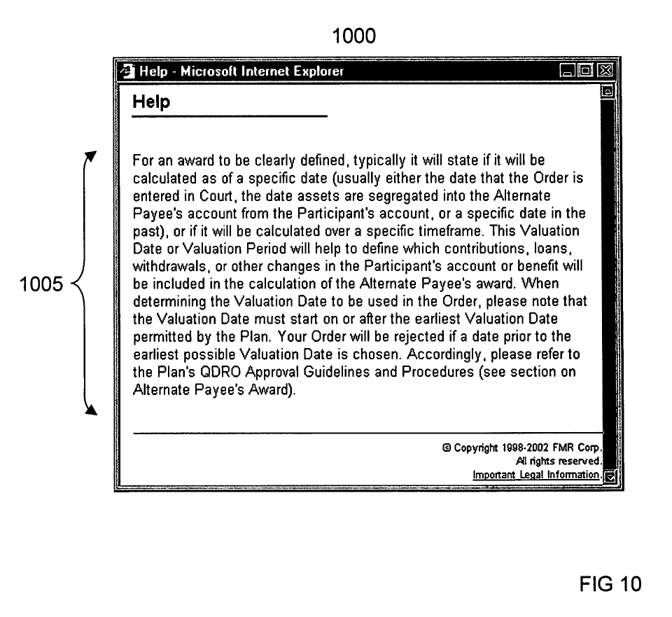

In some embodiments, certain questions or answers may use legal terminology unfamiliar to the plan participant 104. Referring to FIG. 10, to address any confusion or questions, a help screen 1000 that includes help text 1005 is provided when a user of the system selects one of the help icons 915 on other screens throughout the system. In some embodiments, the help screen 1000 is context sensitive, such that when a user selects the help icon 915 positioned on a screen next to a particular term or question, the help text 1005 that appears in the help screen 1000 relates to that particular term or question.

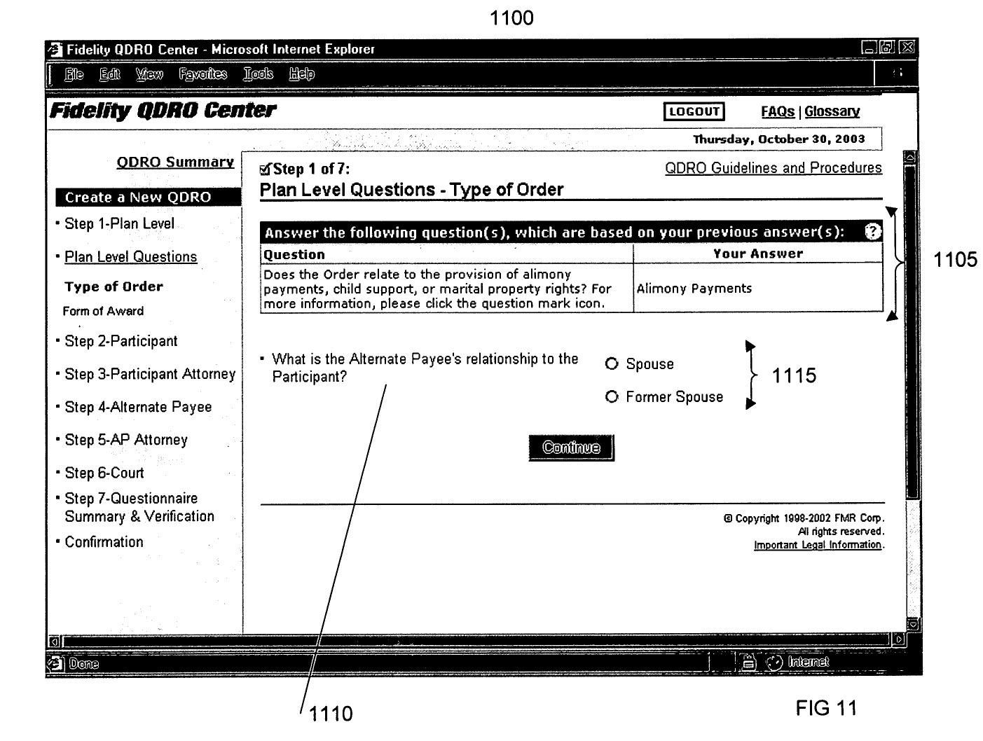

Referring to FIG. 11, once a user has provided an initial set of answers to the online questionnaire, the application server 310 provides a type of order screen 1100 to the client 108 via the communications network 112. The type of order screen 1100 includes answers to previously presented questions 1105, additional questions 1110, and potential answers 1115. By considering the answers to previously presented questions 1105, the system presents only those additional questions 1110 and answers 1115 that are relevant to the particular type of DRO being constructed. For example, where a user indicates the DRO relates to provision of alimony payments, the system responds with questions regarding the relationship of the alternate payee 108 to the participant 104, and limits the available answers to “spouse” and “former spouse.”

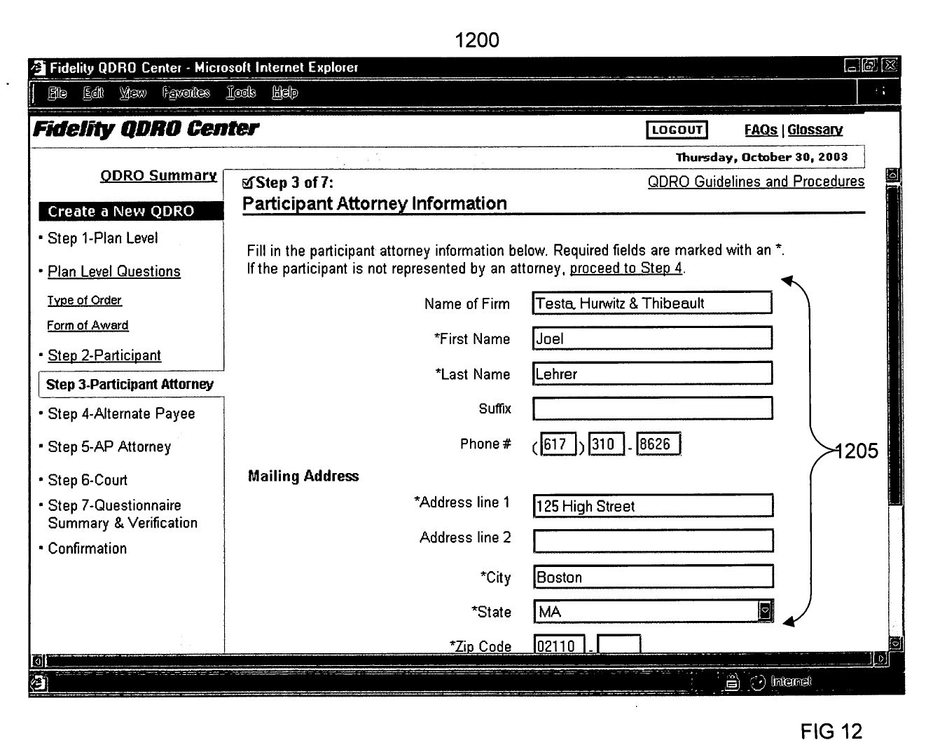

In addition to providing information about the plan participant 104 and the alternate payee 108, the user may also provide information about their legal representative(s). Referring to FIG. 12, the application server 310 provides a participant's attorney screen 1200 to the client 108 via the communications network 112. The participant's attorney screen 1200 includes data fields 1205 for providing the contact information for the participant's attorney 110 such as their name, address, telephone number, and other similar information. In some embodiments, this information is included on the completed DRO.

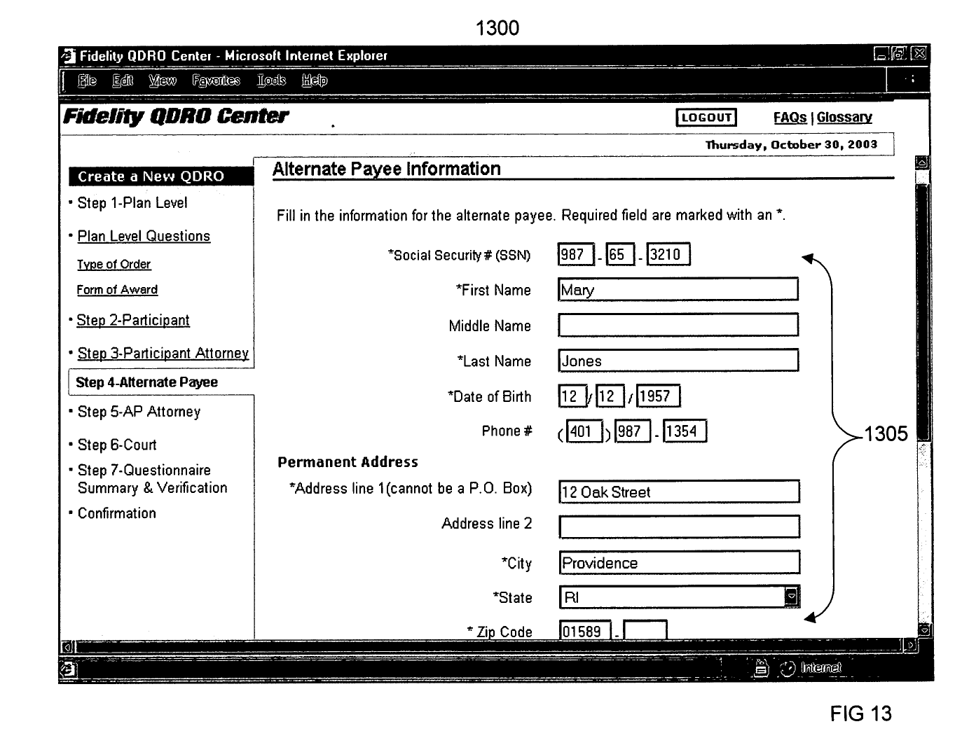

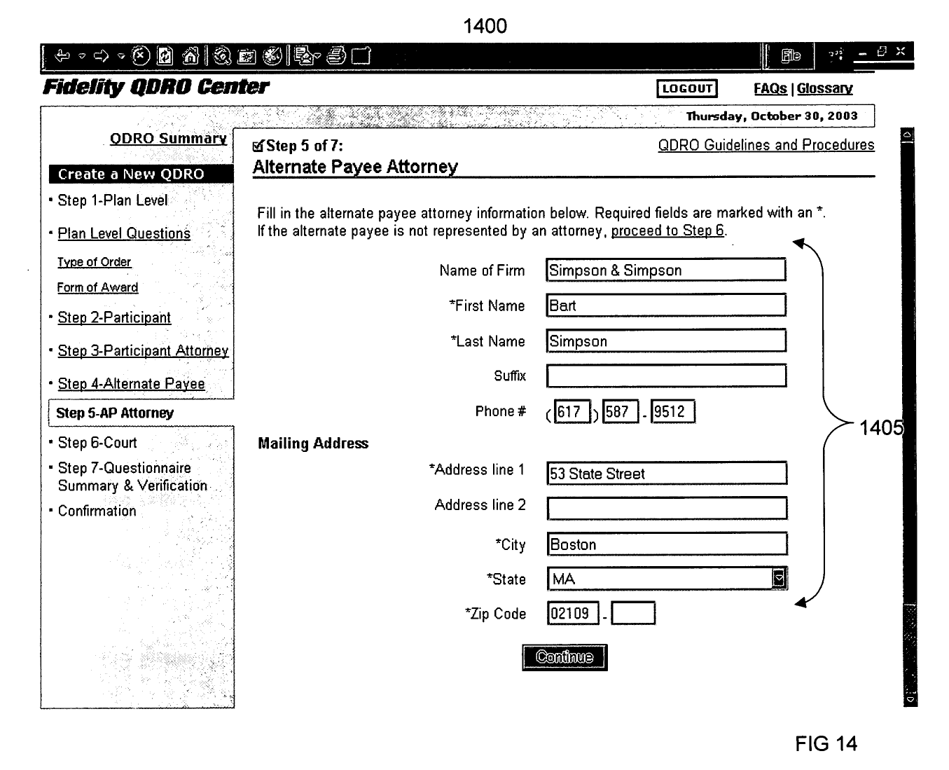

Referring to FIGS. 13 and 14, in one embodiment, the application server 310 provides the user with screens to provide information about the alternate payee 108 and the alternate payee's attorney 112. Referring to FIG. 13, an alternate payee information screen 1300 includes data fields 1305 for users to provide information about the alternate payee 108 for a DRO. In some embodiments, one or more of the data fields are required, and the system will not allow the user to navigate to the next screen without providing the information. For example, where the DRO relates to an alimony payment, the data fields 1305 can be used to provide the name, social security number, date of birth, as well as other contact information about the participant's former spouse. Referring to FIG. 14, once a user provides the system with information concerning the alternate payee 108, the application server 310 provides the user with an alternate payee attorney screen 1400 to provide information about the alternate payee's attorney 112. The alternate payee attorney screen 1400 includes data fields 1405 for users to provide the name, address, telephone number, and other contact information about the alternate payee's attorney 112. In some embodiments, the alternate payee attorney's name and contact information appears on the DRO once the user completes the online questionnaire.

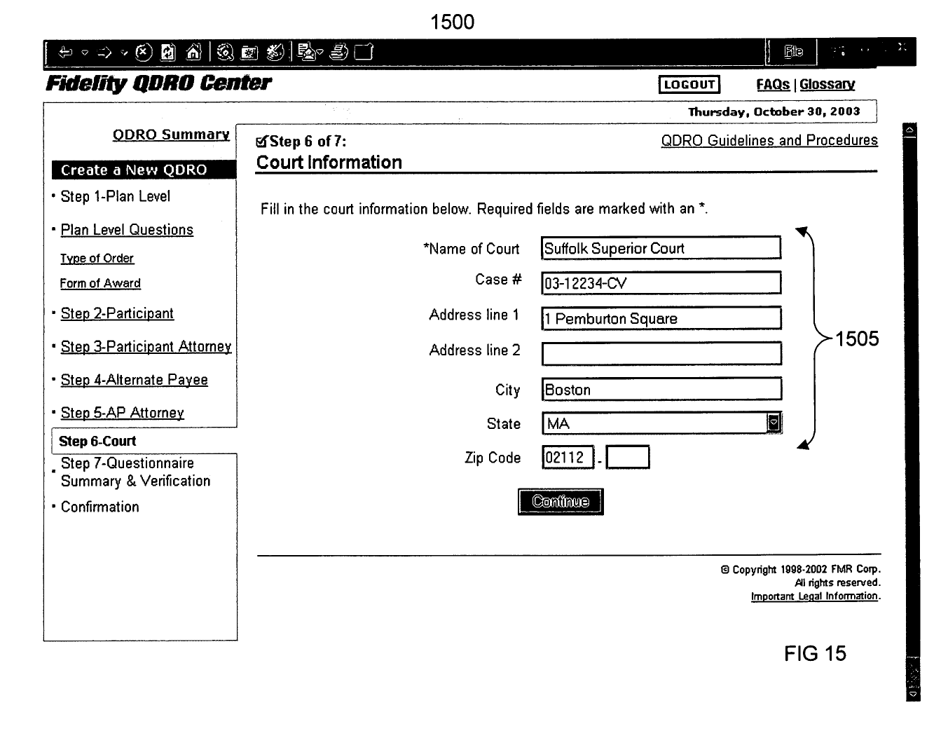

Referring to FIG. 15, once the user has completed the questionnaire screens relating to the plan, the plan participant 104, the alternate payee 108, the participant's attorney 110 and the alternate payee's attorney 112, the application server 310 provides the user with a court information screen 1500, which includes data fields 1505 where user can indicate the name and address of the court that will be issuing the DRO. By requesting this information during the process of assembling the DRO, the system can incorporate the court information into the completed document and assure that it is properly formatted and included in the DRO. This further increases the accuracy of the DRO and the speed at which it can be processed by the plan record keeper 106.

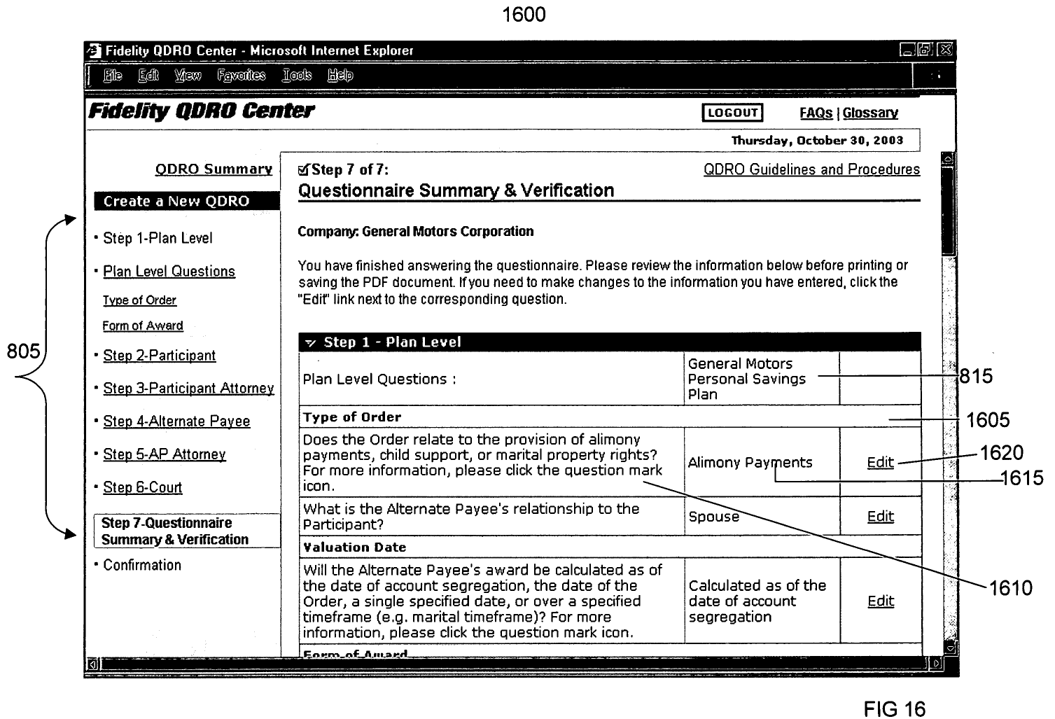

Referring to FIG. 16, once the user provides all the necessary information to complete the DRO, the application server 310 provides the user with a summary and verification screen 1600. In one embodiment, the summary and verification screen 1600 includes the name of the plan 815 for which the DRO is being created, headings 1605 to help organize the data entered by the user into sections that match the step-by-step roadmap 805, the questions 1610 that were presented to the user, the answers provided 1615, and edit buttons 1620 that return the user to the particular screen associated with the edit button 1620, thereby allowing the user to change one or more answers. This review function provides a final step for validation that the information provided is complete and correct, thus significantly increasing the accuracy and completeness of the DRO. Upon completion of the review, the user then creates the DRO by selecting a menu option, clicking an onscreen button, or other mechanism to instruct the server 204 to assemble the DRO.

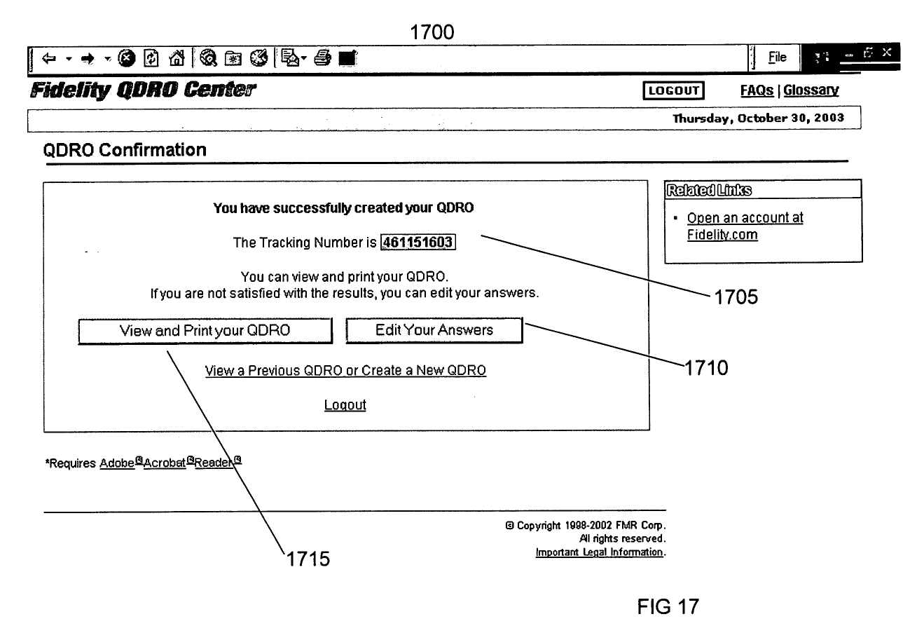

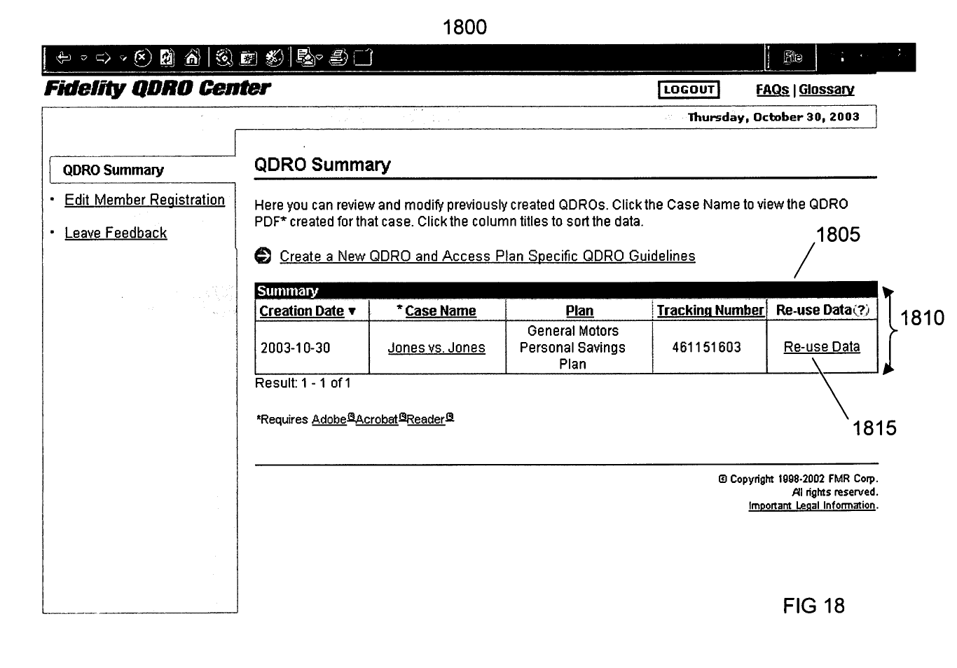

Referring to FIG. 17, in some embodiments, once the DRO is created, it is assigned a tracking number. The application server 310 provides the user with a confirmation screen 1700 that includes the tracking number 1705, and provides the user with an additional opportunity to edit the answers provided through an edit your answers button 1710. If no changes are to be made, the user may then select the view and print button 1715 to view an electronic version of the DRO in a format such as a PDF or other word processing formats. Furthermore, and referring to FIG. 18, if the user logs out of the system and needs to review the DRO at a later time, upon logging into the system the application server 310 provides the user with a summary screen 1800. The summary screen 1800 includes a table 1805 listing the previously created DRO's 1810 stored in the server 204, with descriptive information such as the tracking number, case name, plan, creation date, as well as other data to assist the user in distinguishing one particular DRO from another. In some embodiments, the data from one DRO may be reused to accelerate the process of creating new DROs by selecting the re-use data link 1815. This may be particularly helpful when there are numerous plans affected by one particular life event for a plan participant 104. For example, one plan participant 104 that works for a plan sponsor 100 may participate in a defined contribution plan, a pension plan, and an employee stock purchase plan. If the plan participant gets divorced and as part of the divorce must provide alimony and child support from each plan, a potential of six different DROs may be necessary. It is likely that each DRO will contain similar information, i.e.—the same alternate payee (former spouse), the same court, and the same attorney information, and therefore, this feature reduces the amount of time a plan participant must spend to create multiple DRO's based on similar information.

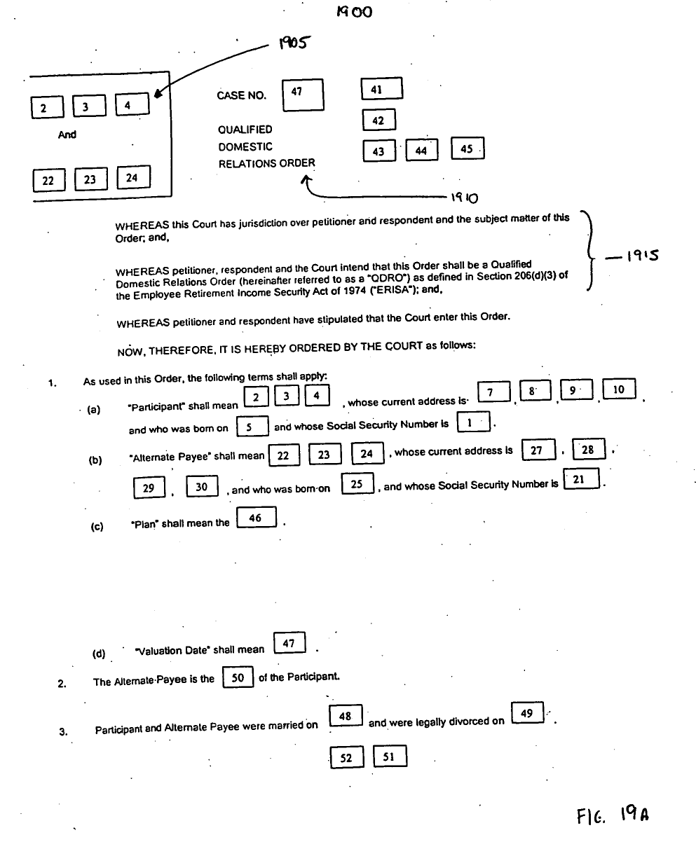

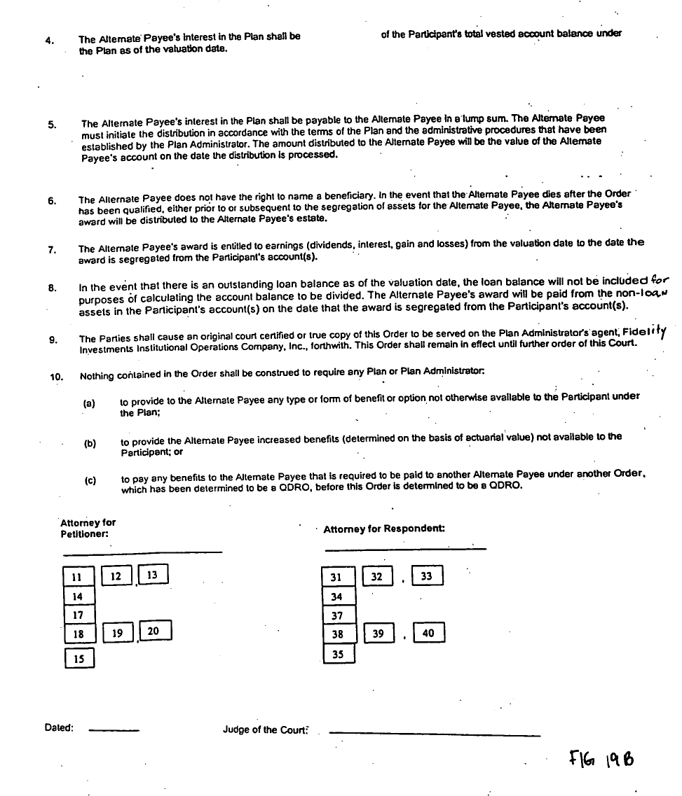

Referring to FIGS. 19A and 19B, the system includes one or more document templates 1900 for creating DROs. In one embodiment, the templates 1900 include parameter fields 1905 into which the system places user-supplied values for the parameters, data identifiers 1910 that describe the parameters, and standard text 1915 that may be common to one or more DROs. In one embodiment, the user supplied values may include their name, address, date of birth and social security number for inclusion into the DRO. In such an example, parameter fields numbered 2, 3, and 4 are replaced with the participants first, middle and last name, parameter fields 7 through 10 are replaced with the street address, city, state and zip code of the participant, parameter field 5 is replaced with the participant's date of birth, and parameter field 1 is replaced with the participant's social security number. Additional information about the participant, the alternate payee, the attorneys, and the court can also be entered into the template. Once complete, the user-provided information and the standard text create a DRO with accurate, legally complete data such that the DRO can be quickly and accurately processed by the plan record keeper.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. A computerized system for producing a domestic relations order comprising:
a receiver for receiving information relating to a domestic relations order;
a rules engine in communication with the receiver for authenticating the received information; and
a document assembler for automatically incorporating the authenticated information into an assembled domestic relations order.

2. The system of claim 1 wherein a subset of the received information is received from a participant in an employee benefit plan.

3. The system of claim 2 wherein, in addition to the subset of the information received from the participant, additional data is received from a legal representative of the participant.

4. The system of claim 3 wherein, in addition to the subset of the information received from the participant and the legal representative of the participant, additional information is further received from an alternate payee of the employee benefit plan.

5. The system of claim 4 wherein, in addition to the subset of the information received from the participant, the legal representative of the participant, and the alternate payee of the employee benefit plan, additional information is further received from a legal representative of the alternate payee of the employee benefit plan.

6. The system of claim 1 further including a data storage device for storing rules relating to a domestic relations order.

7. The system of claim 6 wherein the data storage device further stores sample text passages.

8. The system of claim 7 wherein the sample text passages relate to a domestic relations order.

9. The system of claim 7 wherein the rules engine further selects a subset of the sample text passages based, at least in part, on the stored rules.

10. The system of claim 7 wherein the rules engine further selects a subset of the sample text passages based, at least in part, on the received information.

11. The system of claim 6 wherein the document assembler receives at least a subset of the information from the data storage device, the subset of received information having been previously included in a domestic relations order.

12. The system of claim 1 further comprising an administrative module for maintaining the rules engine.

13. A computerized method for producing a domestic relations order, comprising:
providing a plurality of sample text passages relating to domestic relations orders, the sample text passages including embedded parameters;
requesting information for inclusion into a domestic relations order, the requested information including values for one or more of the embedded parameters;
receiving the requested information; and
automatically assembling the domestic relations order using a subset of the sample text passages and at least a subset of the received information.

14. The method of claim 13 further comprising receiving the information over an electronic communications network.

15. The method of claim 14 wherein the electronic communications network is one of a local area network, a wide area network, a telephone network, an intranet, or the Internet.

16. The method of claim 14 further comprising receiving the information through an online questionnaire.

17. The method of claim 13 further comprising receiving at least a subset of the information from a previously completed domestic relations order.

18. The method of claim 13 further comprising receiving at least a subset of the information from a participant in an employee benefit plan.

19. The method of claim 18 wherein the employee benefits plan is one of a defined contribution plan and a defined benefit plan.

20. The method of claim 13 further comprising receiving at least a subset of the information from a legal representative of a participant in an employee benefit plan.

21. The method of claim 13 further comprising receiving at least a subset of the information from an alternate payee of an employee benefit plan.

22. The method of claim 21 further comprising receiving at least a subset of the information from a legal representative of the alternate payee of an employee benefit plan.

23. The method of claim 22 further comprising providing a set of rules relating to the composition of a domestic relations order.

24. The method of claim 23 wherein the assembly step further comprises determining the subset of the sample text passages based, at least in part, on the rules.

25. The method of claim 13 wherein the designating step further comprises determining if the domestic relations order is compliant with the Internal Revenue Code and Employee Retirement Income Security Act.

26. A computerized system for producing a domestic relations order, comprising:
means for storing sample text passages for inclusion into a domestic relations order, the sample text passages including embedded parameters;
means for receiving information about a first domestic relations order, the information providing values for one or more of the embedded parameters; and
means for automatically assembling a domestic relations order from a the received information and a subset of the stored sample text.
